(19) United States
(12) Patent Application Publication
(10) Pub. No.: US 2026/0001899 A1
(43) Pub. Date: Jan. 1, 2026

(54) METHOD FOR SYNTHESIZING MIXED-CARBENE IRIDIUM(III) COMPLEXES

(71) Applicant: The Hong Kong Polytechnic University, Hung Hom (HK)

(72) Inventors: Wai-Yeung WONG, Hung Hom (HK); Yingjie SUN, Hung Hom (HK)

(73) Assignee: The Hong Kong Polytechnic University, Hung Hom (HK)

(21) Appl. No.: 18/755,438

(22) Filed: Jun. 26, 2024

(51) Int. Cl. C07F 15/00

(52) U.S. Cl. CPC C07F 15/0033

(57) ABSTRACT

A method for synthesizing a variety of mixed-carbene iridium(III) complexes for use as phosphorescent emitters. Organic light-emitting diodes (OLEDs) based on these phosphorescent emitters have a high external quantum efficiency (EQE) on the order of 8.5 and 8.8%, with CIE coordinates on the order of (0.15, 0.09) and (0.15, 0.07), respectively. These properties render them useful for constructing efficient deep blue-emitting OLEDs.

### BACKGROUND OF THE INVENTION

### 1. Field of the Invention

An aspect of the invention relates to an improved synthesis for mixed-carbene iridium(III) complexes suitable for use as deep-blue phosphorescent light emitters in display and lighting applications.

### 2. Description of the Related Art

The fabrication of organic light-emitting diodes (OLEDs) heavily relies on the utilization of cyclometalated iridium(III) complexes. However, achieving high efficiency, maintaining deep blue emission color purity, and ensuring good stability in this field presented significant challenges. Recent studies have revealed the enormous potential of iridium(III) carbene complex due to its excellent stability, outstanding blue emission color purity, and remarkable photoluminescence quantum yield (PLQY). SEE: Lee, J., Chen, H., Batagoda, T., Coburn, C., Djurovich, P. I., Thompson, M. C., & Forrest, S. R, Nat. Mat, 2016, 15, 92-98. https://doi.org/10.1038/nmat4446.

Thomas S. Teets has reported a unique class of cyclometalated iridium(III) complexes that display saturated blue luminescence, demonstrating significant potential for the advancement of blue OLEDs. The general structure of these complexes is Ir(C\hat{ }C:NHC)2(C\hat{ }C:ADC), where they utilize cyclometalating ligands obtained from N-heterocyclic carbene (NHC), along with a distinctive cyclometalating ligand type that incorporates an acyclic diaminocarbene (ADC). SEE: Na, H., Cañada, L. M., Wen, Z., Wu, J. Z., & Teets, T. S, Chem. Sci. 2019, 10, 6254-6260. https://doi.org/10.1039/c9sc01386e.

The PLQY of these complexes are satisfactory with lifetimes in the microsecond range, both of which are crucial criteria for device applications. Although researchers have suggested several methods for the synthesis of mixed-carbene iridium(III) complexes, the intricate synthetic procedures have resulted in low yields. SEE: Molt, Langer, N., & Fuchs, E, Metal Complexes Comprising Diazabenzmidazolocarbene Ligands and the Use Thereof in OLEDS. (Patent No. US20210126207A1). A method for synthesizing these complexes which resulted in higher yields and more efficiently purified output would be a useful invention.

### SUMMARY OF THE INVENTION

Aspects of the present invention provide an improved method for synthesizing mixed-carbene iridium(III) complexes (for purposes of this application also identified as “MCI3C”) suitable for use as emitters in blue OLEDs, display and lighting applications.

The basic chemical structures of MCIC3 1-3 are represented as follows:

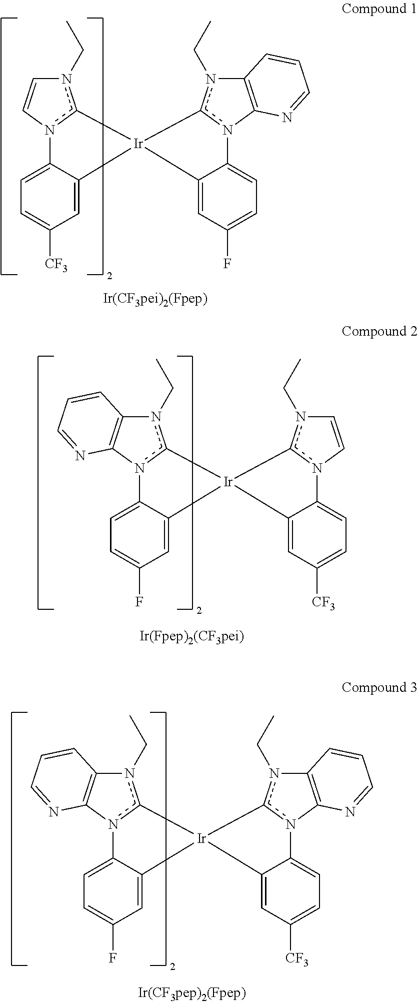

Known syntheses of MCIC3 in the art are very inefficient, producing low yields and therefore also requiring more extensive purification. An improved synthetic route for MCIC3 is represented as follows:

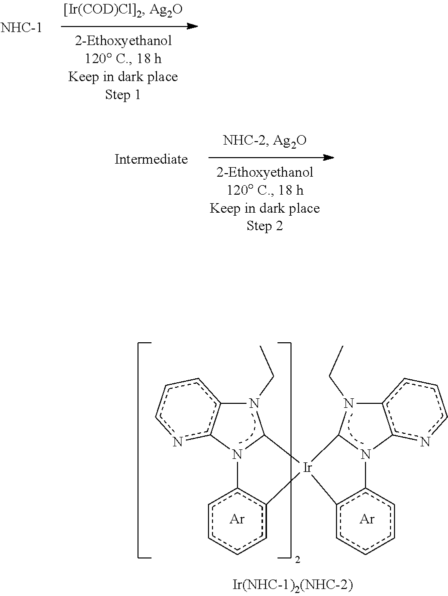

The synthetic method of the invention is simple and widely applicable, with a yield ranging from 20% to 53% for the target product. Characterization of photophysical performance indicates that these complexes are highly efficient deep-blue emitters.

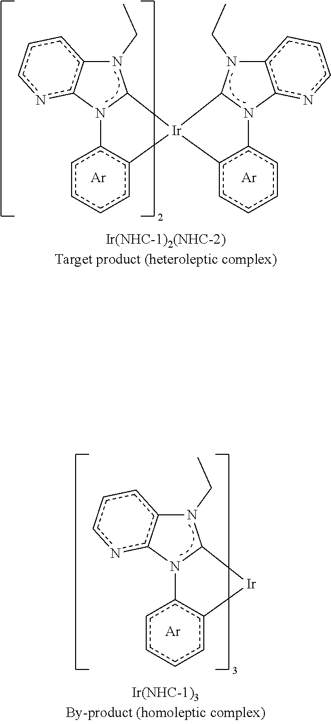

Using the method of the invention allows both the heteroleptic and homoleptic iridium(III) complexes to be obtained simultaneously in a one-pot reaction, which allows experimental comparison of the difference of OLED performance between them.

Experiment discloses that the MCIC3 have superior stability, brightness, and a narrower full width at half maximum (FWHM) in comparison to the homoleptic iridium(III) complexes.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a flow chart showing the basic method of the invention.

### DETAILED DESCRIPTION OF THE EMBODIMENTS

Reference will now be made in detail to several embodiments of the invention that are illustrated in accompanying drawings. Whenever possible, the same or similar reference numerals are used in the drawings and the description to refer to the same or like parts or steps. The drawings are in simplified form and are not to precise scale. For purposes of convenience and clarity only, directional terms such as top, bottom, left, right, up, down, over, above, below, beneath, rear, and front, can be used with respect to the drawings. These and similar directional terms are not to be construed to limit the scope of the invention in any manner. The words attach, connect, couple, and similar terms with their inflectional morphemes do not necessarily denote direct or intermediate connections, but can also include connections through mediate elements or devices.

In the disclosure of the method of the invention, amounts of reactants, products, and ancillary materials (solvents, eluants, filter materials, et cetera) are stated. However, unless specifically noted, the specific amounts disclosed are not required, only ratios as would be understood by a person of ordinary skill in the art. Solvents, eluants, filter materials, et cetera may also be substituted as a person or ordinary skill in the art would anticipate to be acceptable. Likewise, specific reaction times and temperatures are denoted, but unless specifically noted, times and temperatures which a person of ordinary skill in the art would believe to produce substantially similar results are acceptable and will allow the method of the invention to be successfully practiced.

According to an aspect of the invention, an improved synthetic route for MCIC3 is represented in general as follows:

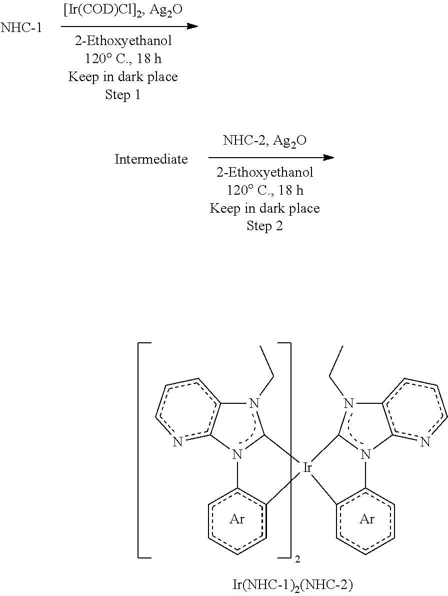

Using the method as set forth below will produce a yield ranging from 20% to 53% for the target MCIC3. Characterization of photophysical performance indicates that these complexes are highly efficient deep-blue emitters.

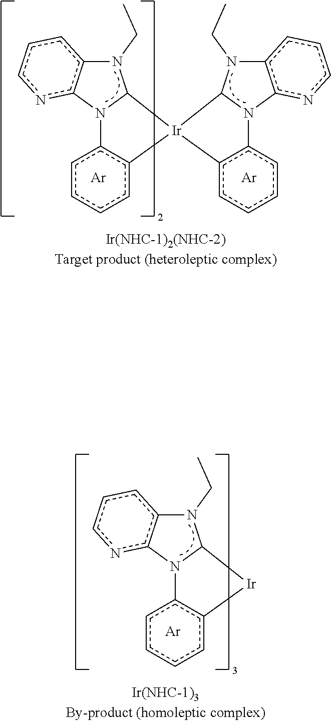

Using the method allows both the heteroleptic and homoleptic iridium(III) complexes to be obtained simultaneously in a one-pot reaction, which allows experimental comparison of the difference of OLED performance between them. The method of the invention will first be described in technical detail as a variety of synthesis procedures, and then as a sequential method containing all required steps to gain the advantage(s) of the invention.

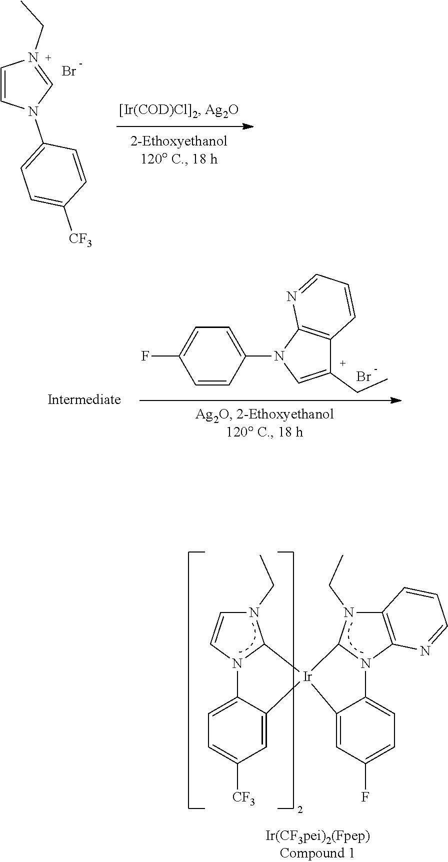

First Synthesis Procedure—Ir(CF₃pei)₂(Fpep): A mixture of 3-ethyl-1-(4-(trifluoromethyl)phenyl)-1H-imidazol-3-ium bromide (192 mg, 0.6 mmol, 3 eq), Ag₂O (92 mg, 0.4 mmol, 2 eq), [Ir(COD)Cl]₂ (134 mg, 0.2 mmol, 1 eq) and 2-ethoxyethanol (10 mL) is added to a Schlenk flask or other suitable reaction vessel, which is then stirred and heated at 120° C. for 18 h under a nitrogen atmosphere. After cooling to room temperature, the precipitate is filtered and washed with dichloromethane (50 mL). The filtrate is concentrated under reduced pressure to obtain the intermediate without any further purification. A mixture of intermediate (178 mg), 1-ethyl-3-(4-fluorophenyl)-3H-imidazo[4,5-b]pyridin-1-ium bromide (141 mg, 0.45 mmol, 2.2 eq), Ag₂O (125 mg, 0.54 mmol, 2.7 eq), and 2-ethoxyethanol (10 mL) is added to the reaction vessel, which is stirred and heated at 120° C. for 18 h under a nitrogen atmosphere. The mixture is allowed to cool down to room temperature and concentrated under reduced pressure, and the residue is purified through column chromatography on silica gel (eluent: n-hexane/ethyl acetate=1:1) to afford the Ir(CF₃pei)₂(Fpep). Yield: 37 mg (20%). ¹H NMR (400.1 Hz, Methylene Chloride-d₂) δ: 8.71 (dd, J=8.6 Hz, 5.2 Hz, 1H), 8.30 (dd, J=4.8 Hz, 1.2 Hz, 1H), 7.47 (m, 2H), 7.40 (d, J=2.0 Hz, 1H), 7.13 (m, 5H), 7.01 (s, 1H), 6.80 (dd, J=12.4 Hz, 2.0 Hz, 2H), 6.65 (s, 1H), 6.57 (qd, J=8.8 Hz, 3.2 Hz, 1H), 6.24 (dd, J=9.6 Hz, 2.8 Hz, 1H), 3.16-3.85 (m, 6H), 0.60-0.77 (m, 9H); ¹³C NMR (100.5 Hz, Methylene Chloride-d₂) δ: 186.7, 173.6, 170.1, 160.8 (d, J=244.1 Hz), 151.5, 150.7, 150.6, 149.9, 149.7, 147.1, 145.2, 143.3, 135.5 (q, J=3.6 Hz), 133.4 (q, J=3.6 Hz), 128.2, 126.6, 126.5, 126.3, 125.5 (q, J=271.8), 123.4, 123.3, 120.8, 119.6, 118.8 (q, J=4.0 Hz), 118.6, (q, J=3.8 Hz), 117.6, 116.9, 115.8, 115.6, 115.5, 110.7, (d, J=2.5 Hz), 107.3, 107.1, 45.2, 45.0, 42.6, 16.4, 16.2, 14.6; ¹⁹F NMR (376.5 Hz, Methylene Chloride-d₂) δ: −61.53 (s, 3 F), −61.62 (s, 3 F), −120.18 (m, 1 F); MS (MALDI-TOF): 910.9055; Found: 911.2165.

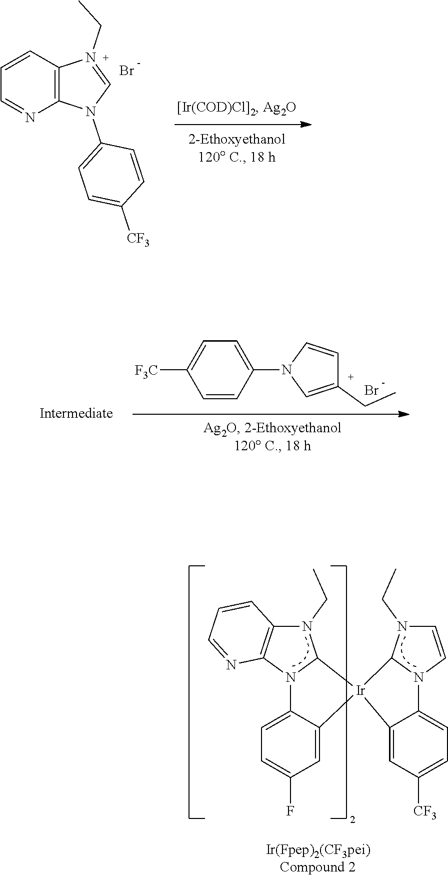

Second Synthesis Procedure—Ir(Fpep)₂(CF₃pei): A mixture of 1-ethyl-3-(4-fluorophenyl)-3H-imidazo[4,5-b]pyridin-1-ium bromide (193 mg, 0.6 mmol, 3 eq), Ag₂O (92 mg, 0.4 mmol, 2 eq), [Ir(COD)Cl]₂ (134 mg, 0.2 mmol, 1 eq) and 2-ethoxyethanol (10 mL) is added to the reaction vessel, which is then stirred and heated at 120° C. for 18 h under a nitrogen atmosphere. After cooling to room temperature, the precipitate is filtered and washed with dichloromethane (50 mL). The filtrate is concentrated under reduced pressure to obtain the intermediate without any further purification. A mixture of intermediate (171 mg), 3-ethyl-1-(4-(trifluoromethyl)phenyl)-1H-imidazol-3-ium bromide (141 mg, 0.45 mmol, 2.2 eq), Ag₂O (125 mg, 0.54 mmol, 2.7 eq), and 2-ethoxyethanol (10 mL) is added to the reaction vessel, which is stirred and heated at 120° C. for 18 h under a nitrogen atmosphere. The mixture is allowed to cool down to room temperature and concentrated under reduced pressure, and the residue is purified through column chromatography on silica gel (eluent: n-hexane/ethyl acetate=1:1) to afford the Ir(Fpep)₂(CF₃pei). Yield: 96 mg (53%). ¹H NMR (400.1 Hz, Methylene Chloride-d₂) δ: 8.74 (q, J=5.2 Hz, 1H), 8.68 (q, J=5.2 Hz, 1H), 8.33 (dd, J=5.2 Hz, 1.6 Hz, 1H), 8.28 (dd, J=4.8 Hz, 1.6 Hz, 1H), 7.50 (m, 3H), 7.11 (m, 5H), 6.84 (d, J=2.0 Hz, 1H), 6.59 (m, 2H), 6.39 (dd, J=9.2 Hz, 3.2 Hz, 1H), 6.18 (dd, J=9.2 Hz, 2.8 Hz, 1H), 3.35-3.74 (m, 6H), 0.83 (t, J=7.2 Hz, 3H), 0.70 (t, J=6.8 Hz, 3H), 0.62 (t, J=7.2 Hz, 3H); ¹³C NMR (100.5 Hz, Methylene Chloride-d₂) δ: 187.5, 184.8, 171.1, 161.2 (dm, J=244.2 Hz), 161.0 (dm, J=245.2 Hz), 152.1, 152.0, 151.2, 147.2, 146.7, 144.4, 143.6, 143.5, 143.4, 135.3 (q, J=3.4 Hz), 128.3, 127.9, 126.5, 126.2, 125.4 (q, J=271.7 Hz), 123.9, 123.8, 122.5, 122.3, 120.7, 119.3 (q, J=4.0 Hz), 117.9, 117.7, 117.3, 117.1, 116.05 (q, J=7.9 Hz), 116.03, 110.5, 107.1 (dd, J=23.5 Hz, 2.6 Hz), 45.2, 43.1, 42.4, 16.4, 15.0, 14.9; ¹⁹F NMR (376.5 Hz, Methylene Chloride-d₂) δ: −61.7 (s, 3 F), −120.0 (m, 1 F), −120.2 (m, 1 F); MS (MALDI-TOF): 911.9477; Found: 912.2272.

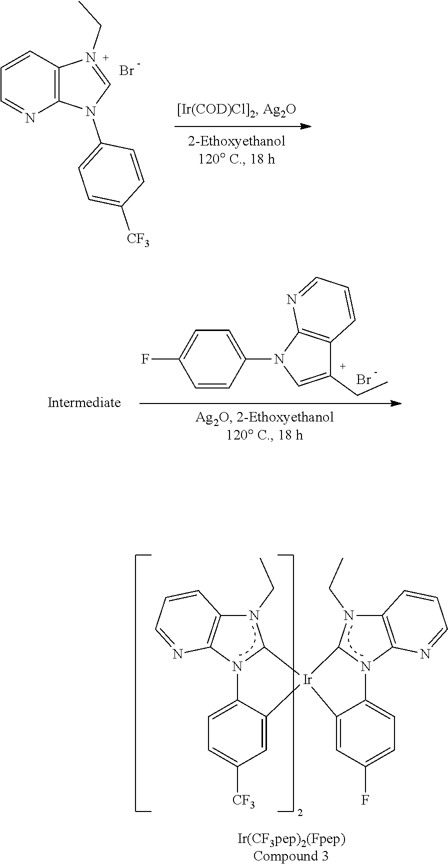

Third Synthesis Procedure—Ir(CF₃pep)₂(Fpep): A mixture of 1-ethyl-3-(4-(trifluoromethyl)phenyl)-3H-imidazo[4,5-b]pyridin-1-ium bromide (223 mg, 0.6 mmol, 3 eq), Ag₂O (92 mg, 0.4 mmol, 2 eq), [Ir(COD)Cl]₂ (134 mg, 0.2 mmol, 1 eq) and 2-ethoxyethanol (10 mL) is added to the reaction vessel, which is stirred and heated at 120° C. for 18 h under a nitrogen atmosphere. After cooling to room temperature, the precipitate is filtered and washed with dichloromethane (50 mL). The filtrate is concentrated under reduced pressure to obtain the intermediate without any further purification. A mixture of intermediate (175 mg), 1-ethyl-3-(4-fluorophenyl)-3H-imidazo[4,5-b]pyridin-1-ium bromide (142 mg, 0.45 mmol, 2.2 eq), Ag₂O (125 mg, 0.54 mmol, 2.7 eq), and 2-ethoxyethanol (10 mL) is added to the reaction vessel, which is stirred and heated at 120° C. for 18 h under a nitrogen atmosphere. The mixture is allowed to cool down to room temperature and concentrated under reduced pressure, and the residue is purified through column chromatography on silica gel (eluent: n-hexane/ethyl acetate=1:1) to afford the Ir(CF₃pep)₂(Fpep). Yield: 46 mg (23%). 1H NMR (400 MHz, Chloroform-d) δ 8.98 (d, J=8.3 Hz, 1H), 8.94 (d, J=8.3 Hz, 1H), 8.87 (dd, J=8.6, 5.0 Hz, 1H), 8.52-8.44 (m, 3H), 7.63 (t, J=8.0 Hz, 1H), 7.60-7.53 (m, 2H), 7.37-7.29 (m, 3H), 7.27-7.20 (m, 2H), 7.15 (s, 1H), 6.76-6.70 (m, 2H), 6.46 (dd, J=9.2, 2.8 Hz, 1H), 3.93 (dd, J=13.9, 7.1 Hz, 1H), 3.80 (dq, J=14.4, 7.1 Hz, 3H), 3.65 (dq, J=13.5, 6.9 Hz, 2H), 0.94 (t, J=7.1 Hz, 3H), 0.83 (t, J=7.2 Hz, 3H), 0.78 (t, J=7.1 Hz, 3H). 19F NMR (565 MHz, DMSO-d₆) δ −61.37, −61.41, −118.25.

By referring to the provided drawings and the above disclosure, the basic method of the invention can be easily understood.

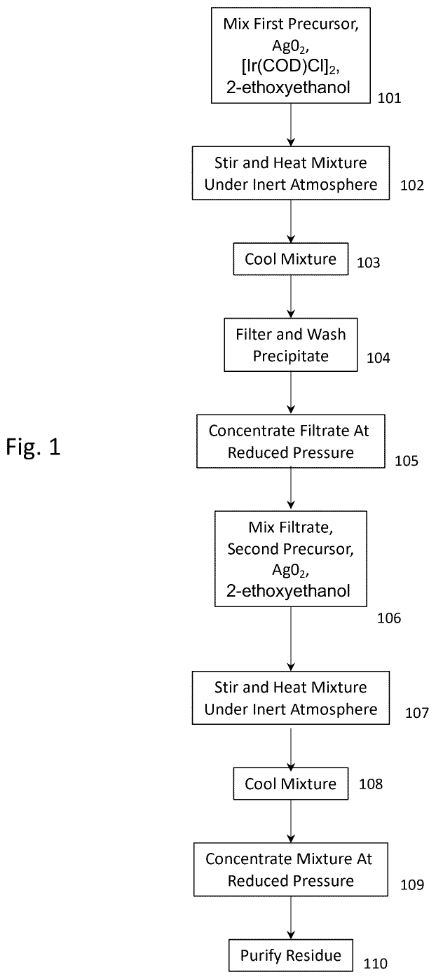

FIG. 1 shows the steps of the method of the invention.

In Step 101, the base mixture of the first precursor, which varies as described above according to the particular method being used, AgO₂, [Ir(COD)Cl]₂, and 2-ethoxyethanol is added to a reaction vessel to form a first mixture.

In Step 102, the first mixture is stirred and heated in an inert atmosphere, such as nitrogen.

In Step 103, the first mixture is cooled, usually to room temperature.

In Step 104, the precipitate is filtered and washed in a suitable solvent such as dichloromethane.

In Step 105, the filtrate is concentrated at a reduced pressure.

In Step 106, the filtrate, also known as an intermediate, is mixed with a second precursor, which varies as described above according to the particular method being used, AgO₂, and 2-ethoxyethanol to form a second mixture.

In Step 107, the second mixture is stirred and heated in an inert atmosphere, such as nitrogen.

In Step 108, the second mixture is cooled, usually to room temperature.

In Step 109, the second mixture is concentrated at reduced pressure.

In Step 110, the residue is purified by an appropriate method, such as the use of column chromatography on silica gel to produce the final product, which will have a high concentration of one or more of the MCIC3 compounds described above.

While not forming part of the claimed invention, the use of the product of the invention for the fabrication of deep-blue LED is also described below.

As shown above on the left (a) an example deep-blue OLED comprises the following elements: indium tin oxide (ITO)/1,4,5,8,9,11-hexaazatriphenylenehexacarbonitrile (HAT-CN, 20 nm)/1,1-bis[(di-4-tolylamino)phenyl]cyclohexane (TAPC, 40 nm)/Ir(CF₃pei)₃, 5 nm/Ir phosphors doped diphenyl[4-(triphenylsilyl)phenyl]phosphine oxide (TSPO1) (10 wt %, 20 nm)/diphenyl[4-(triphenylsilyl)phenyl]phosphine oxide (TSPO1, 20 nm)/(LiF, 1 nm)/Al (100 nm). The elements are configured as shown in the structural diagram on the right (b.)

The diagrams below compare the performance difference between homoleptic and heteroleptic complexes.

Device characteristics of Ir(CF₃pei)₃, Ir(CF₃pei)₂(Fpep), Ir(Fpep)₃ and Ir(Fpep)₂(CF₃pei) as the emitters at a concentration of 10 wt %. The EL spectra of MCIC3 complexes resemble the PL spectra recorded in the toluene solution. Devices based on MCIC3 achieved a maximum brightness beyond 450 cd m⁻² and exhibited excellent deep-blue emissions, with peak maximum located in the 425-427 nm region, and a narrowed FWHM of 65 and 77 nm, corresponding to the CIE_{x,y} coordinates of (0.15, 0.09) and (0.15, 0.07). As shown in Table 7, the external quantum efficiency or EQE value and color purity of deep blue OLEDs based on MCIC3 are superior to those of homoleptic iridium(III) complexes.

The anticipated electroluminescence performances of devices using MCIC3 at the doping ratio of 10 wt % are as follows.

| | Vₒₙ | Lₘₐₓ | EQEₘₐₓ | CEₘₐₓ | PEₘₐₓ | EL | FWHM | CIE^{b} |
|---|---|---|---|---|---|---|---|---|
| Emitter | (V)^{a} | (cd m⁻²) | (%) | (cd A⁻¹) | (lm W⁻¹) | (nm)^{b} | (nm) | (x, y) |
| Ir(CF₃pei)₃ | 4.3 | 300 | 7.8 | 5.4 | 4.2 | 426 | 78 | (0.16, 0.10) |
| Ir(CF₃pei)₂(Fpep) | 3.6 | 456 | 8.8 | 6.6 | 5.1 | 425 | 77 | (0.15, 0.09) |
| Ir(Fpep)₃ | 4.8 | 164 | 8.0 | 6.0 | 3.8 | 425 | 77 | (0.16, 0.10) |
| Ir(Fpep)₂(CF₃pei) | 3.2 | 475 | 8.5 | 4.9 | 3.8 | 427 | 65 | (0.15, 0.07) |

^{a}Recorded at a current density of 0.01 mA cm⁻²;
^{b}Those recorded at a current density of 10 mA cm⁻².

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method for synthesizing a mixed-carbene iridium(III) complex, comprising the steps of:
adding a base mixture of 3-ethyl-1-(4-(trifluoromethyl)phenyl)-1H-imidazol-3-ium bromide, Ag₂O, [Ir(COD)Cl]₂ and 2-ethoxyethanol to a reaction vessel to create a first mixture;
stirring and heating the first mixture under an inert atmosphere;
cooling the first mixture;
filtering and washing the first mixture to obtain a first filtrate;
adding the first filtrate, 1-ethyl-3-(4-fluorophenyl)-3H-imidazo[4,5-b]pyridin-1-ium bromide, Ag₂O, and 2-ethoxyethanol to the reaction vessel to create a second mixture;
stirring and heating the second mixture under an inert atmosphere;
cooling the second mixture; and
purifying the second mixture to obtain a final mixture containing the mixed-carbene iridium(III) complex.

2. The method for synthesizing a mixed-carbene iridium(III) complex of claim 1, further comprising the steps of:
concentrating the first mixture under reduced pressure after the step of filtering and washing the first mixture; and
concentrating the second mixture under reduced pressure after the step of cooling the second mixture.

3. The method for synthesizing a mixed-carbene iridium(III) complex of claim 2, wherein the first mixture is washed with dichloromethane.

4. The method for synthesizing a mixed-carbene iridium(III) complex of claim 3, wherein the second mixture is purified through column chromatography.

5. A method for synthesizing a mixed-carbene iridium(III) complex, comprising the steps of:
adding a base mixture of 1-ethyl-3-(4-fluorophenyl)-3H-imidazo[4,5-b]pyridin-1-ium bromide, Ag₂O, [Ir(COD)Cl]₂ and 2-ethoxyethanol to a reaction vessel to create a first mixture;
stirring and heating the first mixture under an inert atmosphere;
cooling the first mixture; and
filtering and washing the first mixture to obtain a first filtrate;
adding the first filtrate, 3-ethyl-1-(4-(trifluoromethyl)phenyl)-1H-imidazol-3-ium bromide, Ag₂O, and 2-ethoxyethanol to the reaction vessel to create a second mixture;
stirring and heating the second mixture under an inert atmosphere;
cooling the second mixture; and
purifying the second mixture to obtain a final mixture containing the mixed-carbene iridium(III) complex.

6. The method for synthesizing a mixed-carbene iridium(III) complex of claim 5, further comprising the steps of:
concentrating the first mixture under reduced pressure after the step of filtering and washing the first mixture; and
concentrating the second mixture under reduced pressure after the step of cooling the second mixture.

7. The method for synthesizing a mixed-carbene iridium(III) complex of claim 6, wherein the first mixture is washed with dichloromethane.

8. The method for synthesizing a mixed-carbene iridium(III) complex of claim 7, wherein the second mixture is purified through column chromatography.

9. A method for synthesizing a mixed-carbene iridium(III) complex, comprising the steps of:
adding a base mixture of 1-ethyl-3-(4-(trifluoromethyl)phenyl)-3H-imidazo[4,5-b]pyridin-1-ium bromide, Ag₂O, [Ir(COD)Cl]₂ and 2-ethoxyethanol to a reaction vessel to create a first mixture;
stirring and heating the first mixture under an inert atmosphere;
cooling the first mixture; and
filtering and washing the first mixture to obtain a first filtrate;
adding the first filtrate, 1-ethyl-3-(4-fluorophenyl)-3H-imidazo[4,5-b]pyridin-1-ium bromide Ag₂O, and 2-ethoxyethanol to the reaction vessel to create a second mixture;
stirring and heating the second mixture under an inert atmosphere;
cooling the second mixture; and
purifying the second mixture to obtain a final mixture containing the mixed-carbene iridium(III) complex.

10. The method for synthesizing a mixed-carbene iridium(III) complex of claim 9, further comprising the steps of:
concentrating the first mixture under reduced pressure after the step of filtering and washing the first mixture; and
concentrating the second mixture under reduced pressure after the step of cooling the second mixture.

11. The method for synthesizing a mixed-carbene iridium(III) complex of claim 10, wherein the first mixture is washed with dichloromethane.

12. The method for synthesizing a mixed-carbene iridium(III) complex of claim 11, wherein the second mixture is purified through column chromatography.
